(19) United States
(12) Patent Application Publication
(10) Pub. No.: US 2024/0367749 A1
(43) Pub. Date: Nov. 7, 2024

(54) SUSPENSION ASSEMBLY FOR A TILTING VEHICLE

(71) Applicant: SCUTER S.R.L., Roma (IT)

(72) Inventor: Carmine DI NUZZO, Roma (IT)

(73) Assignee: SCUTER S.R.L., Roma (IT)

(21) Appl. No.: 18/689,638

(22) PCT Filed: Sep. 5, 2022
(86) PCT No.: PCT/IB2022/058319

§ 371 Date: Mar. 6, 2024

(30) Foreign Application Priority Data
Sep. 6, 2021 (IT) 102021000022931

(51) Int. Cl. B62K 25/04; B62K 5/05; B62K 5/10

(52) U.S. Cl. CPC B62K 25/04; B62K 5/10; B62K 5/05

(57) ABSTRACT

A suspension assembly for a tilting vehicle, including: a chassis element, rigid and fixed with respect to the vehicle; right and left arms, where each has an inner end hinged on the chassis element and an outer end, configured for being constrained on a wheel, which can oscillate upwards and downwards; and a linear shock absorber assembly. In the suspension assembly, the ends of the linear shock absorber assembly are respectively hinged on the right arm and on the left arm. The suspension assembly further includes steering components having a steering shaft, a shift plate, and a right and left steering rods. The steering shaft is rotatable around a steering axis and includes a protrusion. The protrusion is hinged in the middle of the shift plate and each steering rod has an inner end hinged on the shift plate and an outer end configured for being constrained on a wheel.

### TECHNICAL FIELD

The present invention refers to the sector of tilting vehicles having three or more wheels, in particular to a suspension assembly suitable for such a vehicle type.

### BACKGROUND

In the field of motorised urban mobility, two-wheeled vehicles, such as motorcycles and mopeds, are particularly appreciated, since they allow the user to proceed easily in traffic and, once at their destination, to easily find a suitable parking area. However, it is known that the urban environment comprises numerous pitfalls for two-wheeled vehicles, like the discontinuities of the road surface, represented for example by the rails of the trams and by the manholes of the drainage wells; the different pavements that alternate along the paths, such as asphalt, sett, cobblestone, etc.; the presence of surfaces on the road bottom that become easily slippery when they are wet, such as some types of horizontal signs and the leaves fallen from the trees. All these situations, often combined with heavy traffic, represent a high potential risk, if the user of the two-wheeled vehicle is forced to brake sharply or even simply has to tackle a curve without having been able to slow down adequately. In such situations, in fact, one or both wheels can easily lose grip and cause the vehicle and therefore the user to fall to the ground.

Tilting vehicles with three or four wheels have been proposed to solve these problems. Such tilting vehicles can tilt sideways (according to the movement known as rolling) to tackle curves, just as motorcycles do. They are particularly appreciated because although they are light and manageable like motorcycles, they provide a greater stability than the latter, especially in the case of braking or a sudden curve.

Often in such tilting vehicles, the front axle comprises two side-by-side wheels and the rear axle comprises only one central wheel. In other, less common solutions, the rear axle also comprises two side-by-side wheels. In both cases, it is required that the front axle is tilting.

To obtain the two-wheeled suspension assembly, typically at the front axle, the various manufacturers have adopted various technical solutions. In this type of front axle, in fact, each of the two wheels must be guaranteed the possibility of making various movements. A first type of movement, common to many vehicles, is that of vertical translation typical of the suspensions. Such movement allows, for example, the absorption of the irregularities in the road surface or to react to an increase in load. In relation to this movement, it is good that each wheel can translate independently of the other wheel. A second type of movement, typical of these tilting vehicles, is the one that allows rolling. This movement is a vertical translation but, unlike the previous one, it is a differential movement: the more one wheel is raised with respect to the vehicle chassis (for example the right one), the more the other wheel must be lowered (in the example, the left one) to maintain ground contact. Finally, a third type of movement necessary for the front axle is the well-known one of the rotation that allows the steering action.

Many of the known technical solutions, in order to be able to guarantee the correct operation of the tilting vehicle, are rather complicated. As the skilled person can well understand, the more complicated the mechanical solutions are, the heavier, more expensive and potentially prone to failures and malfunctions they are.

Furthermore, in some of these known technical solutions, the kinematics of the front axle introduces unwanted links between the different types of movement. For example, some kinematic configurations imply that a high vertical excursion introduces an undesired steering angle.

Thus, there is a need in the art for a new tilting suspension assembly for a vehicle.

### OBJECTS AND SUMMARY OF THE INVENTION

Aim of the present invention is to overcome the drawbacks of the prior art.

In particular, it is the task of the present invention to make available a tilting suspension assembly with a structure alternative to known solutions.

Furthermore, a task of the present invention is to make available a tilting suspension assembly having a simpler structure than those known. In this way, the structure of the tilting suspension assembly of the invention may be lighter, cheaper and less prone to failures and malfunctions than the known solutions.

Finally, another task of the present invention is to make available a tilting suspension assembly that does not introduce any undesired link between the different types of movement of the wheels.

These and other objects of the present invention are achieved by a tilting suspension assembly and a vehicle in accordance with the appended claims, which form an integral part of the present disclosure.

In accordance with a first aspect, the invention concerns a suspension assembly for a tilting vehicle, comprising:
a chassis element, rigid and fixed with respect to the vehicle;
a right arm and a left arm, wherein each arm has an inner end hinged on the chassis element and an outer end, configured for being constrained on a wheel, which can oscillate upwards and downwards; and
a linear shock absorber assembly comprising an elastic element and a damping element,
wherein the ends of the shock absorber assembly are respectively hinged on the right arm and on the left arm.

The suspension assembly of the invention allows to have an alternative structure with respect to the known solutions, in particular a simpler structure with respect to the known ones. For example, the invention allows a limited number of arms and a single shock absorber assembly to be used.

Further, the suspension assembly comprises steering components configured for controlling the steering movement. The steering components comprise:
a steering shaft;
a shift plate;
a right steering rod and a left steering rod;

wherein:
the steering shaft is constrained on the chassis element so as to be rotatable around a steering axis s;
the steering shaft comprises a protrusion;
the protrusion rigidly extends away from axis s;
the protrusion is hinged in the middle of the shift plate;
each steering rod has an inner end hinged on the shift plate; and
each steering rod has an outer end configured for being constrained on a wheel.

The arrangement of these steering components makes it possible to obtain a tilting and steering suspension assembly, having an alternative structure with respect to the known solutions, in particular a simpler structure than those known. Thanks to this structure, the shift plate remains substantially parallel to itself during the steering movements. This solution helps to decouple the movements allowed to the wheel by the suspension and by the steering.

Preferably, the suspension assembly further comprises a right wheel carrier and a left wheel carrier, wherein the outer end of the right arm is hinged on the right wheel carrier and the outer end of the left arm is hinged on the left wheel carrier. A hub on which a wheel can be mounted extends from the outer surface of each wheel carrier.

This solution makes it easy to mount a wheel on each side of the suspension assembly.

Preferably each of the arms of the suspension assembly has a triangular or fork shape. This type of arm is also called wishbone. A hinge side of the triangle is constrained on the chassis element and defines the hinge at the inner end, while the other two sides converge at the outer end of the arm.

This shape gives the arm a high rigidity with respect to longitudinal stresses and at the same time allows to limit the overall dimensions at the outer end of the arm itself.

Preferably, each of the arms of the suspension assembly comprises an extension configured for holding the hinge on which the linear shock absorber unit is constrained.

The presence of the extensions makes it easy to obtain a kinematics suitable for the use of a linear shock absorber assembly of the type commonly available commercially. Furthermore, this makes it possible to avoid mechanical interferences between different elements of the suspension assembly in all possible configurations of use.

In accordance with some embodiments, each of the arms of the suspension assembly is part of an articulated quadrilateral.

Preferably, the suspension assembly comprises an upper right arm and a lower right arm hinged on the chassis element at a predetermined distance from each other; the outer ends of the two right arms are hinged on the right wheel carrier, so as to provide an articulated quadrilateral; the suspension assembly comprises an upper left arm and a lower left arm hinged on the chassis element at a predetermined distance from each other; and the outer ends of the two left arms are hinged on the left wheel carrier, so as to provide an articulated quadrilateral.

The special structure of the articulated quadrilateral allows the wheel carrier, and thus the wheel, to be maintained in a predetermined orientation with respect to the chassis during the oscillation of the suspension arm.

Preferably, the suspension assembly comprises spherical hinges.

Preferably, in a plan view in a neutral configuration with respect to the steering, the hinges which constrain the inner ends of the steering rods on the shift plate are aligned along a longitudinal axis with the hinge which constrains the inner end of the respective arm on the chassis element.

Preferably, in a plan view in a neutral configuration with respect to the steering, the hinge which constrains the outer end of each steering rod on the respective wheel carrier is aligned along a longitudinal axis with the hinge which constrains the outer end of the respective arm on the same wheel carrier.

This configuration allows to further decouple the different movements of the wheel.

Preferably, the hinge which constrains each steering rod on the respective wheel carrier is retracted with respect to the hinge which constrains the respective arm on the same wheel carrier.

In accordance with a second aspect, the invention concerns a vehicle comprising a suspension assembly in accordance with what is described above.

Preferably, the vehicle comprises a tilting and steering suspension assembly in accordance with what is described above, included in the front axle of the vehicle.

Further features and advantages of the present invention will be more evident from the description of the accompanying drawings.

### BRIEF DESCRIPTION OF THE DRAWINGS

The invention will be described below with reference to some examples, provided by way of non-limiting example, and illustrated in the appended claims. These drawings illustrate different aspects and embodiments of the present invention and reference numerals illustrating structures, components, materials and/or similar elements in different drawings are indicated by similar reference numerals, where appropriate.

FIG. 1 is an axonometric view of a tilting vehicle in accordance with the invention;

FIG. 2 is a front view of the vehicle of FIG. 1, in a laterally tilted configuration;

FIG. 3 is a front schematic view of a suspension assembly of the invention, in a rest configuration;

FIG. 4 is a schematic view of the suspension assembly of FIG. 3, in a laterally tilted configuration;

FIG. 5 is a schematic view of the suspension assembly of FIGS. 3 and 4, in a configuration of passing over an obstacle;

FIG. 6 is a schematic plan view of a front axle of the invention, in a straight road configuration;

FIG. 7 is a schematic view of the front axle of FIG. 3, in a curve configuration;

FIG. 8 is a front view of a tilting front axle in accordance with the invention, in a configuration similar to that of FIG. 5;

FIG. 9 is an axonometric view of the front axle of FIG. 8, wherein the wheels have been removed for greater clarity;

FIG. 10 is a front view of the front axle of FIG. 9, in which some parts have been removed for greater clarity;

FIG. 11 is an axonometric view of the front axle of FIG. 9; and

FIG. 12 is another axonometric view of the front axle of FIG. 9.

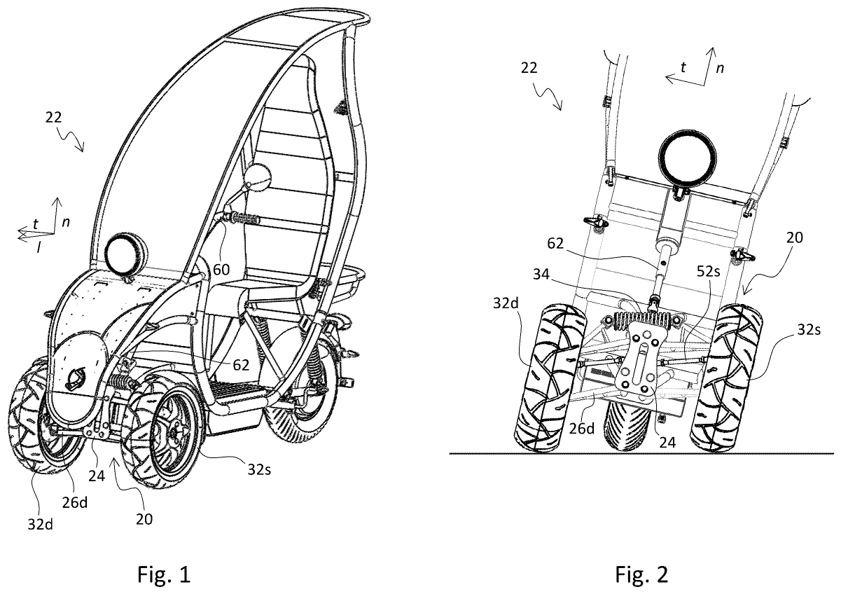

### DETAILED DESCRIPTION OF THE INVENTION

While the invention is susceptible to various modifications and alternative constructions, certain preferred embodiments are shown in the drawings and are described hereinbelow in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The use of “for example”, “etc.”, “or” indicates non-exclusive alternatives without limitation unless otherwise indicated. The use of “includes” means “includes, but not limited to” unless otherwise indicated.

The invention is intended to be applied in the presence of gravity acceleration g, on which base the vertical direction and the horizontal directions are uniquely defined.

In the following discussion it is understood that on the basis of the gravity acceleration g the terms “above”, “upper”, “high” and the like are also uniquely defined with respect to the terms “below”, “lower”, “low” and the like.

The vehicle of the invention, in a per se known manner, has a front end and a rear end. In relation to these ends, the terms “forward”, “front”, and the like are uniquely defined with respect to the terms “behind”, “rear” and the like. In addition, the term “inside” means a position relatively close to the vehicle centreline, while the term “outside” means a position relatively far from the vehicle centreline, to the right or to the left.

In the present discussion, the expression “the element A is hinged on the element B” means that a hinged constraint is provided between the element A and the element B. As is known to the skilled person, the hinged constraint, which can be realized in various ways, allows a mutual rotation movement to take place between the two elements, around at least one axis, but prevents mutual translation movements.

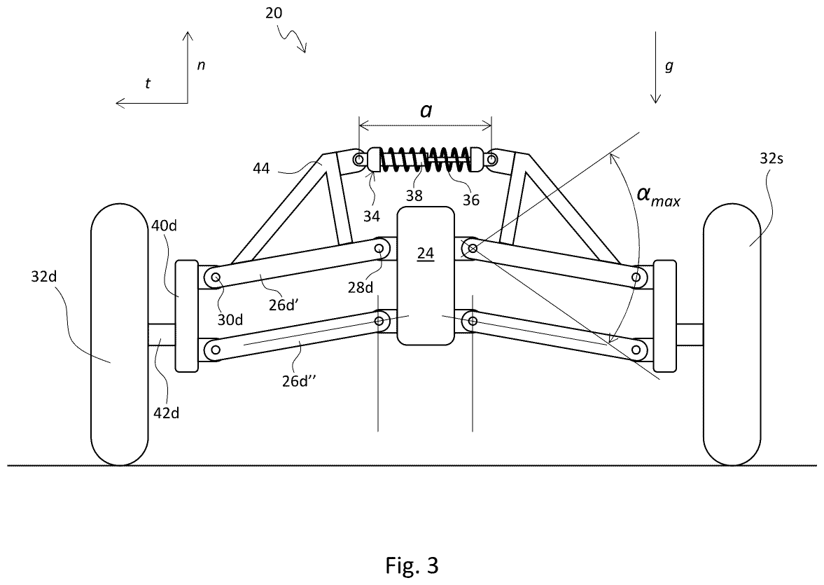

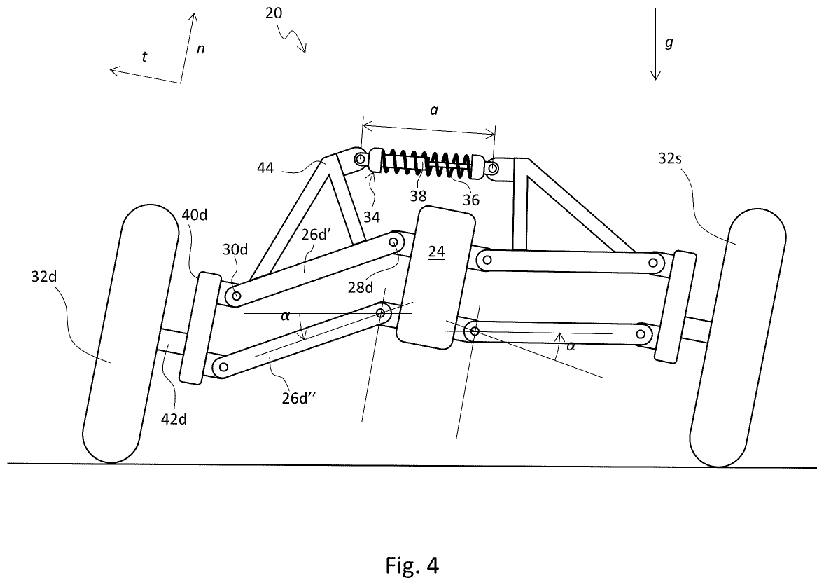

Moreover, intuitively and in itself widely known to the skilled person, the vehicle of the invention defines a longitudinal axis l, a transverse axis t and a normal axis n, where the three axes are perpendicular to each other. By convention, it is considered here that the longitudinal axis l is oriented towards the front of the vehicle, and that the transverse axis t is oriented to the right of the vehicle. The normal axis n is oriented upwards. When the vehicle is in a rest configuration (e.g. the one schematized in FIG. 3) the normal axis n is vertical and the transverse axis t is horizontal, while in other configurations (e.g. the one schematized in FIG. 4) the normal axis n may deviate from the vertical and the transverse axis t may deviate from the horizontal. Finally, when the vehicle is in a rest configuration the longitudinal axis l is horizontal, while in other configurations (e.g. during an acceleration or braking phase, not shown) the longitudinal axis l may deviate from the horizontal.

The axes l, n and t define, two by two, three planes integral with the vehicle: the plane ln (or normal longitudinal plane), the plane lt (or transverse longitudinal plane) and the plane nt (or normal transverse plane).

In accordance with the common conventions adopted in describing vehicle dynamics, a rotation movement around the transverse axis t is defined as pitch, a rotation movement around the longitudinal axis/is defined as roll, and a rotation movement around the normal axis n is defined as yaw.

The vehicle and the suspension assembly of the invention are defined as tilting. In this way it is intended to highlight how they are free to make a roll movement while keeping all the wheels on the ground, for example in order to assume a laterally tilted configuration to correctly set a curve, exactly as it happens for a two-wheeled vehicle such as a moped or a motorcycle.

The vehicle and the suspension assembly of the invention are structurally symmetrical with respect to the normal longitudinal plane ln. In the following discussion, for simplicity's sake, some descriptions are provided in detail only in relation to one side, for example the right side, but they also apply in the same way to the other side, in the example the left side. When it is useful to distinguish similar elements arranged on both sides, the relative numerical reference will be accompanied by an index “d” to indicate the element on the right side and an index “s” to indicate the element on the left side.

With reference to the accompanying figures, a suspension assembly 20 for a tilting vehicle 22 is described, in accordance with some embodiments of the invention. The suspension assembly 20 of the invention comprises:
a chassis element 24, rigid and fixed in relation to the vehicle 22;
a right arm 26d and a left arm 26s, wherein each arm 26 has an inner end 28 hinged on the chassis element 24 and an outer end 30 configured for being constrained on a wheel 32, which can oscillate upwards and downwards; and
a linear shock absorber assembly 34 comprising an elastic element 36 and a damping element 38,
   wherein the ends of the linear shock absorber assembly 34 are respectively hinged on the right arm 26d and on the left arm 26s.

The detailed description that follows makes specific reference to FIGS. 3 to 5, in which the structure of the suspension assembly 20 is shown in a schematic and simplified way, for greater expository clarity. In such figures, for example, various elements have been omitted which in the embodiments are preferably present on the suspension assembly 20, but which, not being directly connected to the structure of the invention, would unnecessarily complicate the representation.

As the skilled person may well understand, the chassis element 24 may take different forms in the different embodiments. For example, the chassis element 24 may comprise a monolithic, box-like, truss-like, or similar structure. The function of the chassis element 24 is to stably connect the suspension assembly 20 to the chassis of the vehicle 22.

Each of the two arms 26 has an inner end 28, close to the centreline of the vehicle 22, and an outer end 30, far from the centreline of the vehicle 22. Preferably, each of the two arms 26 develops mainly along the transverse axis t; each of the two arms 26 can also partially develop along the other two axes l and n of the vehicle 22.

Preferably, the suspension assembly 20 further comprises a right wheel carrier 40d and a left wheel carrier 40s. For greater clarity, only the right side is described in detail below; as the skilled person can well understand, the same description also applies to the left side, which is perfectly symmetrical with respect to the right side. The outer end 30 of the right arm 26d is hinged on the right wheel carrier 40d. In a per se known manner, the hub 42 on which the right wheel 32d can be mounted extends from the outer surface of the right wheel carrier 40d.

The outer end 30 of each arm 26 can oscillate upwards and downwards, rotating around the axis defined by the hinge provided at the inner end 28. The suspension assembly 20 is therefore configured so that the outer end 30 of each of the two arms 26 can move freely along an arc of circumference.

Advantageously, the suspension assembly 20 defines an upper end stop and a lower end stop for each of the two arms 26. Between the upper end stop and the lower end stop, each arm 26 can freely travel an arc of circumference αₘₐₓ comprised between about 10° and about 40°, preferably between about 15° and about 35°.

Depending on the specific structure of the hinge which constrains the inner end 28, and therefore depending on the resulting kinematic specification, the arc of circumference αₘₐₓ described by the outer end 30 of the arm 26 may have different components. The main component is the one along the direction of the normal axis n, but there may also be a minor component along the longitudinal direction l. A third component is linked to the variation of the cosine of the angle formed by the arm 26 with the transverse direction t.

In a side view, along the axis t, the arc of circumference appears as a stroke segment comprised in the plane ln. In accordance with some embodiments, the stroke segment extends only along the direction n. More generally, however, the stroke segment extends mainly along the direction n and partly also along the longitudinal direction l. This stroke segment therefore defines, in the plane ln, a direction o of oscillation of the suspension assembly 20 that can be parallel to the axis n or slightly inclined with respect to it.

The suspension assembly 20 comprises a linear shock absorber assembly 34, itself widely known in the vehicle sector, comprising an elastic element 36 and a damping element 38. The elastic element 36 is preferably a spring, even more preferably a cylindrical, linear or progressive helical spring. The damping element 38 is preferably a viscous damper, for example a hydraulic shock absorber. Preferably, in a per se known manner in the vehicle sector, the cylindrical helical spring and the hydraulic shock absorber are arranged in parallel with each other according to a pattern; even more preferably the cylindrical helical spring and the hydraulic shock absorber are arranged coaxially.

The linear shock absorber assembly 34 is preferably arranged so that, in a rest configuration, it is parallel to the axis t and is located astride the centreline of the vehicle 22. The linear shock absorber assembly 34 therefore comprises a right end and a left end, respectively hinged on the right arm 26d and on the left arm 26s of the suspension assembly 20.

As already mentioned above in relation to the prior art, starting from a rest situation in which the suspension assembly 20 is subjected only to the own weight of the vehicle 22 in a symmetrical configuration (see FIG. 3), the movement of the two arms 26 can be decomposed into two possible basic movements.

The first basic movement (see FIG. 4) is the one linked to the lateral inclination of the vehicle 22, or roll, and is a differential movement of the two arms 26 in which when one arm 26 oscillates upwards by an angle α, the other arm 26 oscillates downwards by an equal angle α. In this movement, the arms 26 are completely free since, except only for the unavoidable frictions and inertia forces, there is no force opposing this movement within the limits defined by the upper stop end and by the lower stop end. As can be noted from a visual comparison between FIGS. 3 and 4, this differential movement has no effect on the length a of the linear shock absorber assembly 34, which remains unchanged.

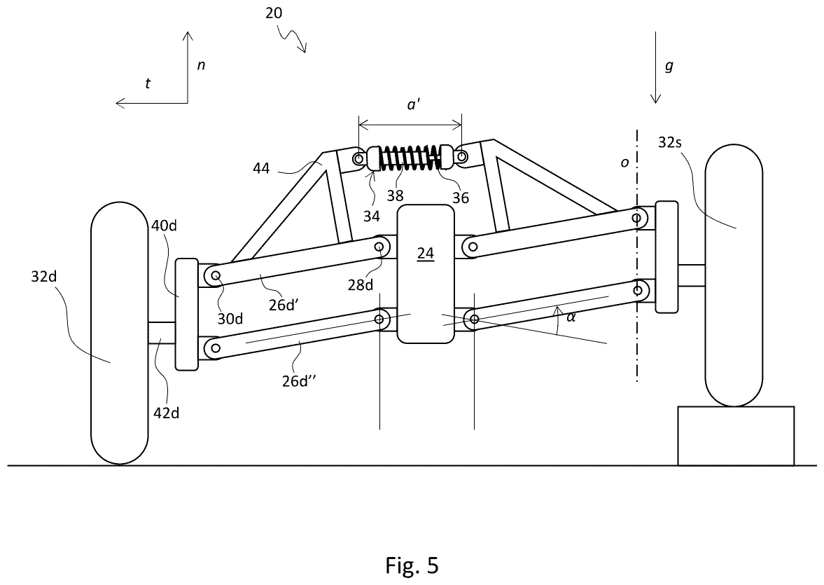

In the second basic movement (see FIG. 5), linked for example to the absorption of irregularities of the ground and/or a change in the vertical load acting on the suspension assembly 20, the two arms 26 can move independently of each other. As can be noted from a visual comparison between FIGS. 3 and 5, this movement involves the linear shock absorber assembly 34, to which a variation in length is imposed. In particular, in the configuration of FIGS. 3-5, the linear shock absorber assembly 34 is compressed from length a to length a′. In this second movement the arms 26 are not free, but are counteracted by the reaction of the linear shock absorber assembly 34.

Preferably, the amplitude of the angle αₘₐₓ is defined by the first type of differential movement. Within this arc there is also comprised the amplitude of the second movement, which amplitude can preferably be comprised within about 15°, preferably within about 10°. The maximum amplitude of the second movement is preferably defined by the maximum compression of the cylindrical helical spring.

As the skilled person may well understand, in each actual operating condition of the vehicle 22, the two movements are generally present simultaneously and overlapping each other inseparably.

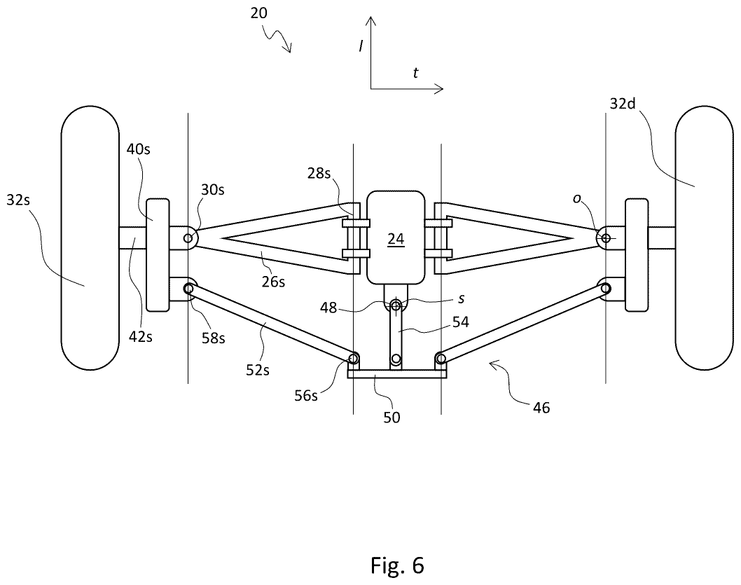

Preferably each of the arms 26 of the suspension assembly 20, when seen along the direction n, has a triangular or fork shape. In the technical field of the suspensions, this type of arm is also called wishbone. One hinge side of the triangle is constrained on the chassis element 24 so as to define the hinge at the inner end 28, while the other two sides converge at the outer end 30 of the arm 26; see for example FIG. 6. The hinge side of the triangle preferably lies in the plane ln and is perpendicular to the axis o of oscillation of the suspension assembly 20.

The triangular configuration, known per se, gives the arm 26 a high rigidity with respect to the stresses along the axis l and at the same time allows to limit the overall dimensions at the outer end 30 of the arm 26 itself. This effect is particularly useful, as will be described below in more detail, to allow the wheel 32 to steer.

Preferably, each of the arms 26 of the suspension assembly 20 comprises an extension 44 configured for holding the hinge on which the linear shock absorber unit 34 is constrained. Preferably, the extension 44 is spaced apart from the arm 26 along the direction n.

Preferably, each of the arms 26 of the suspension assembly 20 is part of an articulated quadrilateral, also comprising the respective wheel carrier 40. For greater clarity, only the right side is described in detail below; as the skilled person can well understand, the same description also applies to the left side, which is perfectly symmetrical with respect to the right side. The suspension assembly 20 preferably comprises two right arms 26d, in particular an upper right arm 26d′ and a lower right arm 26d″. These two right arms 26d, preferably parallel to each other, are hinged on the chassis element 24 at a predetermined distance from each other along the direction n. Further, the outer ends 30 of the two right arms 26d are hinged on the right wheel carrier 40d, preferably at the same distance as the inner ends 28. In this way an articulated quadrilateral, preferably an articulated parallelogram, is obtained. In a per se known manner, the hub 42 on which the right wheel 32d can be mounted extends from the outer surface of the right wheel carrier 40d. The special structure of the articulated quadrilateral keeps the wheel carrier 40, and thus the wheel 32, in a predetermined orientation with respect to the chassis during the oscillation of the suspension arm 26. In particular, the structure of the articulated parallelogram keeps the wheel 32 parallel to itself during the oscillation of the suspension arm 26.

Preferably, when the articulated quadrilateral is adopted, the extensions 44 are arranged on the upper arms 26 and develop upwards. In this way it is easier to obtain a kinematics suitable for the use of a linear shock absorber assembly 34 of the type commonly available commercially. Moreover, such a configuration makes it possible to avoid mechanical interferences between different elements of the suspension assembly 20 in all possible configurations of use.

In accordance with some embodiments of the invention, the suspension assembly 20 described above is intended to be comprised in the front axle, or front end, of a tilting vehicle 22.

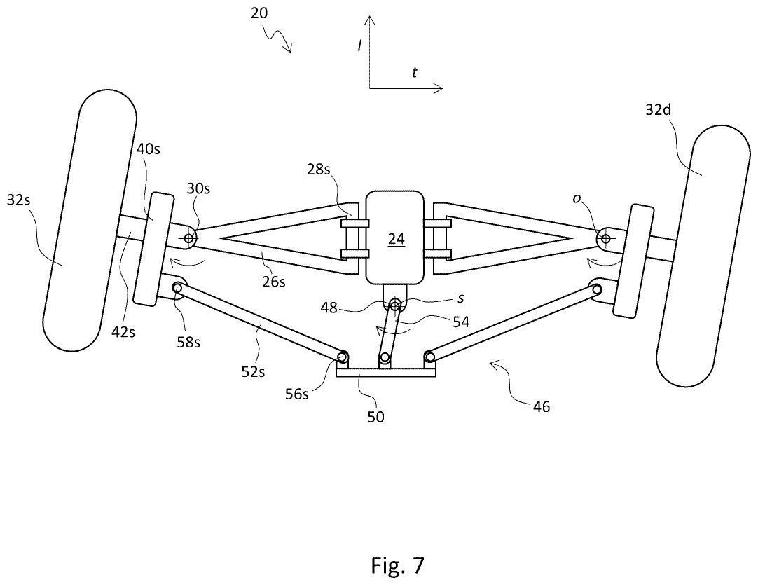

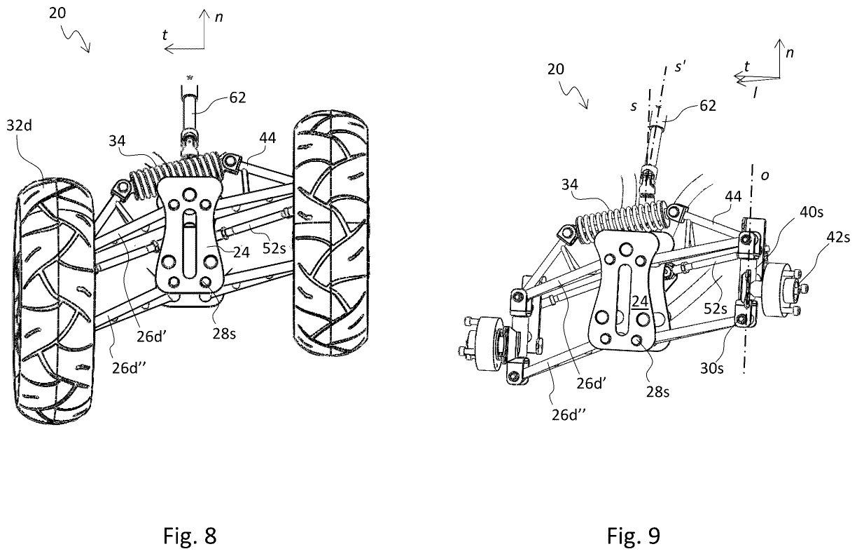

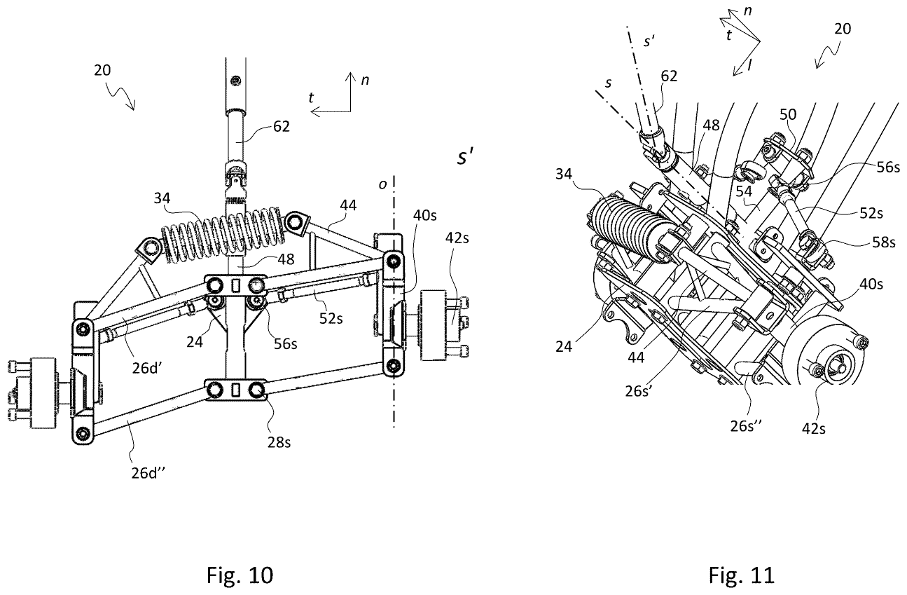

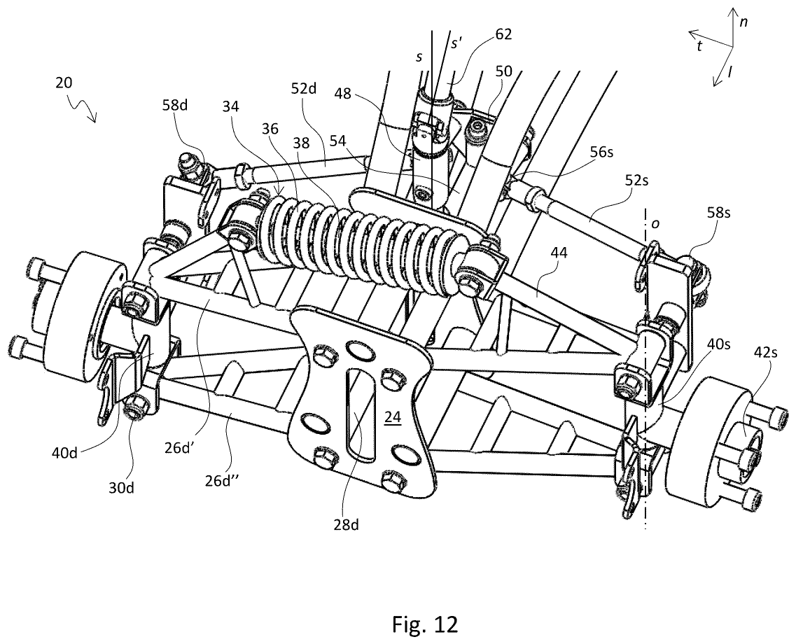

The suspension assembly 20 also comprises steering components 46 configured for controlling the steering movement. Such steering components 46 are described below with particular reference to FIGS. 6 and 7.

The steering components 46 of the suspension assembly 20 of the invention comprise:
a steering shaft 48;
a shift plate 50;
a right steering rod 52d and a left steering rod 52s;
   wherein:
the steering shaft 48 is constrained on the chassis element 24 so as to be rotatable around a steering axis s;
the steering shaft 48 comprises a protrusion 54;
the protrusion 54 rigidly extends away from axis s;
the protrusion 54 is hinged in the middle of the shift plate 50;
each steering rod 52 has an inner end 56 hinged on the shift plate 50; and
each steering rod 52 has an outer end 58 configured for being constrained on a wheel 32.

Preferably, the steering axis s is parallel to the axis of oscillation o, described above in relation to the movement of the suspension assembly 20.

Preferably, the inner end 56s of the left steering rod 52s is hinged on the shift plate 50 to the left with respect to the protrusion 54, and the inner end 56d of the right steering rod 52d is hinged on the shift plate 50 to the right with respect to the protrusion 54.

Preferably, the outer end 58s of the left steering rod 52s is hinged on the left wheel carrier 40s, and the outer end 58d of the right steering rod 52d is hinged on the right wheel carrier 40d.

Preferably, the steering components 46 are arranged behind the suspension assembly 20. In particular, it is preferable that one or more of the following conditions occur: the steering shaft 48 is constrained on the chassis element 24 in a retracted position with respect to the hinges of the arms 26; and/or the protrusion 54 extends backwards from the axis s; and/or the hinges which constrain each steering rod 52 on the respective wheel carrier 40 are retracted with respect to the hinge which constrains the respective arm 26 on the same wheel carrier 40.

Preferably some of the hinges described must be spherical hinges, i.e. they must ensure the rotation in space around a hinge point. As the skilled person may well understand, such a result may be achieved in several, structurally different but functionally analogous ways. For example, a spherical hinge can be obtained with a spherical bearing, with an elastomeric bearing, or by arranging two single-axis hinges so that the respective axes are incident at the hinge point, similar to what happens in a cardan joint. In accordance with some embodiments, a spherical hinge may be approximated by means of two single-axis hinges arranged so that the respective axes, although not incident, are close to each other at the hinge point.

Preferably at least some of the following hinges are spherical:
the hinges which constrain the outer ends 30 of the arms 26 on the respective wheel carrier 40; and/or
the hinges which constrain the inner ends 56 of the steering rods 52 on the shift plate 50; and/or
the hinges which constrain the outer ends 58 of the steering rods 52 on the respective wheel carrier 40.

Let's consider now in particular FIG. 6, which shows a plan view of the steering suspension assembly 20 of the invention while assuming a neutral configuration with respect to steering, i.e. a configuration that, in the absence of other external forces, imposes a rectilinear trajectory on the vehicle 22. In such a configuration, preferably, the protrusion 54 of the steering shaft 48 is aligned along the axis l. Further, preferably, the hinges which constrain the inner ends 56 of the steering rods 52 to the shift plate 50 are aligned along the axis/with the hinge which constrains the inner end 28 of the respective arm 26 on the chassis element 24. More particularly, in a plan view in a neutral configuration, the hinge which constrains the inner end 56d of the right steering rod 52d on the shift plate 50 is aligned along the axis l with the hinge which constrains the inner end 28d of the right arm 26d on the chassis element 24; and the hinge which constrains the inner end 56s of the left steering rod 52s on the shift plate 50 is aligned along the axis l with the hinge which constrains the inner end 28s of the left arm 26s on the chassis element 24.

Preferably, moreover, in such a configuration the hinge which constrains the outer end 58 of each of the steering rods 52 on the respective wheel carrier 40 is aligned along the axis l with the hinge which constrains the outer end 30 of the respective arm 26 on the same wheel carrier 40. More particularly, in a plan view in a neutral configuration, the hinge which constrains the outer end 58s of the left steering rod 52s on the left wheel carrier 40s is aligned along the axis l with the hinge which constrains the outer end 30s of the left arm 26s on the same left wheel carrier 40s; likewise, the hinge which constrains the outer end 58d of the right steering rod 52d on the right wheel carrier 40d is aligned along the axis l with the hinge which constrains the outer end 30d of the right arm 26d on the same right wheel carrier 40d.

By way of example, let's consider below what happens when a rightward steering action is imposed. In this regard, compare FIGS. 6 and 7. To impose a rightward steering action, the steering shaft 48 is rotated clockwise, thereby imposing a leftward displacement on the protrusion 54 that is rigidly integral with the steering shaft 48. Following the displacement of the protrusion 54 to the left, the shift plate 50 also undergoes a similar displacement to the left. During this displacement, the shift plate 50 remains substantially parallel to itself. Following the leftward displacement of the shift plate 50, the inner ends 56 of the steering rods 52 also undergo a similar leftward displacement. During this displacement, the right steering rod 52d operates on the right wheel carrier 40d as a tie rod, while the left steering rod 52s operates on the left wheel carrier 40s as a strut. In this way, each wheel carrier 40 rotates in a concordant manner with the steering shaft 48 (in the example, clockwise) around an axis parallel to the steering axis s and passing through the hinge which constrains it on the respective arm 26.

In a second aspect, the invention concerns a vehicle 22 comprising at least one suspension assembly 20 in accordance with what is described above. The vehicle 22 comprises a chassis on which at least one suspension assembly 20 is mounted in accordance with what is described above. Preferably, the suspension assembly 20 is comprised in the front axle, or front end, of the vehicle 22 and therefore advantageously comprises the steering components 46 described above. Preferably, the vehicle 22 further comprises a right wheel 32d mounted on the hub 42d extending from the right wheel carrier 40d and a left wheel 32s mounted on the hub 42s extending from the left wheel carrier 40s.

Preferably, the vehicle 22 further comprises a steering control 60 rotatable around a steering control axis s′. The steering axis s, defined by the steering shaft 48, and the steering control axis s′, defined by the steering control 60, are generally comprised in the plane ln. They may, however, be neither parallel nor incidental to each other (see e.g. FIG. 11). In such a case, the steering control 60 advantageously comprises a steering column 62, connected to the steering shaft 48 by means of transmission means, for example by means of one or more cardan joints. In this way, the rotation imposed by the user by means of the steering control 60 is transmitted to the steering shaft 48.

As the skilled person may well understand, the present discussion considers a completely neutral alignment of the wheels 32, that is with null angles of camber, canter and toe. Naturally, the variation of one of these angles does not imply any difficulty for the skilled person since it does not imply any modification to the structure of the invention.

Preferably, the vehicle 22 may also comprise other elements that may be necessary or advantageous for the user. These elements are not considered in the foregoing discussion nor in the attached figures, because they are not directly related to the invention. For example, the vehicle 22 may comprise an engine with the relative auxiliary systems, a braking system, an electrical system with the relative lights, a seat, and so on.

As the person can well understand from the above description, the invention allows to overcome the drawbacks of the prior art.

In particular, the invention makes available a tilting suspension assembly 20 having an alternative structure with respect to known solutions.

Furthermore, the invention makes available a tilting suspension assembly 20 which has a simpler structure than those known. In this way, the structure of the tilting suspension assembly 20 of the invention is, compared to the known solutions, lighter, cheaper and less prone to failures and malfunctions.

Finally, the invention makes available a tilting suspension assembly 20 that does not introduce any undesirable link between the different types of movement of the wheels.

In the foregoing discussion, the characteristics of the vehicle 22 directly related to the invention have been described in detail. For the other characteristics of the vehicle 22, in themselves known, what is reported in the introductory part in relation to the prior art applies.

All the details described above can be replaced by other technically equivalent elements. At the same time, the technical characteristics described by way of example in relation to a specific embodiment can be extrapolated and applied to other embodiments.

In practice, the materials used, as well as the contingent shapes and sizes, can be whatever according to the requirements without for this reason departing from the scope of protection of the following claims.

1-13. (canceled)

14. A suspension assembly for a tilting vehicle, comprising:
a chassis element, rigid and fixed with respect to the vehicle;
a right arm and a left arm, wherein each arm has an inner end hinged on the chassis element and an outer end, configured for being constrained on a wheel, which can oscillate upwards and downwards; and
a linear shock absorber assembly comprising an elastic element and a damping element,
wherein the ends of the linear shock absorber assembly are respectively hinged on the right arm and on the left arm;
wherein the suspension assembly further comprises steering components, configured for controlling a steering movement, comprising:
a steering shaft;
a shift plate;
a right steering rod and a left steering rod;
and wherein:
the steering shaft is constrained on the chassis element so as to be rotatable around a steering axis s;
the steering shaft comprises a protrusion;
the protrusion rigidly extends away from axis s;
the protrusion is hinged in the middle of the shift plate;
each steering rod has an inner end hinged on the shift plate; and
each steering rod has an outer end configured for being constrained on a wheel.

15. The suspension assembly according to claim 14, further comprising a right wheel carrier and a left wheel carrier, wherein the outer end of the right arm is hinged on the right wheel carrier and the outer end of the left arm is hinged on the left wheel carrier and wherein from the outer surface of each wheel carrier a hub extends on which a wheel can be mounted.

16. The suspension assembly according to claim 14, wherein each of the arms of the suspension assembly has a triangular or fork shape, and wherein a hinge side of the triangle is constrained on the chassis element and defines the hinge at the inner end, while the other two sides converge at the outer end of the arm.

17. The suspension assembly according to claim 14, wherein each of the arms of the suspension assembly comprises an extension configured for holding the hinge on which the linear shock absorber assembly is constrained.

18. The suspension assembly according to claim 15, wherein each of the arms of the suspension assembly is part of an articulated quadrilateral.

19. The suspension assembly according to claim 18, wherein:
the suspension assembly comprises an upper right arm and a lower right arm hinged on the chassis element at a predetermined distance from each other;
the outer ends of the two right arms are hinged on the right wheel carrier, so as to provide an articulated quadrilateral;
the suspension assembly comprises an upper left arm and a lower left arm hinged on the chassis element at a predetermined distance from each other; and
the outer ends of the two left arms are hinged on the left wheel carrier, so as to provide an articulated quadrilateral.

20. The suspension assembly according to claim 14, wherein the outer end of the left steering rod is hinged on the left wheel carrier and the outer end of the right steering rod is hinged on the right wheel carrier.

21. The suspension assembly according to claim 14, wherein:
the hinges which constrain the outer ends of the arms on the respective wheel carrier are spherical hinges; and/or
the hinges which constrain the inner ends of the steering rods on the shift plate are spherical hinges; and/or
the hinges which constrain the outer ends of the steering rods on the respective wheel carrier are spherical hinges.

22. The suspension assembly according to claim 14, wherein, in a plan view in a neutral configuration with respect to the steering, the hinges which constrain the inner ends of the steering rods on the shift plate are aligned along a longitudinal axis with the hinge which constrains the inner end of the respective arm on the chassis element.

23. The suspension assembly according to claim 14, wherein, in a plan view in a neutral configuration with respect to the steering, the hinge which constrains the outer end of each of the steering rods on the respective wheel carrier is aligned along a longitudinal axis to the hinge which constrains the outer end of the respective arm on the same wheel carrier.

24. The suspension assembly according to claim 14, wherein the hinge which constrains each steering rod on the respective wheel carrier is retracted with respect to the hinge which constrains the respective arm on the same wheel carrier.

25. A tilting vehicle comprising at least one suspension assembly according to claim 14.

26. The tilting vehicle according to claim 25, wherein the suspension assembly is comprised in the front axle of the vehicle.
